(19) United States
(12) Patent Application Publication
(10) Pub. No.: US 2019/0392037 A1
(43) Pub. Date: Dec. 26, 2019

(54) Intelligent Visual Inquiry Method and System

(71) Applicant: NANJING NICEBRIDGE INFORMATION TECHNOLOGY CO., LTD, Nanjing, Jiangsu (CN)

(72) Inventors: Zhiyang Guo, Nanjing, Jiangsu (CN); Jian Qiao, Nanjing, Jiangsu (CN); Qihang Chen, Nanjing, Jiangsu (CN); Pengcheng Wu, Nanjing, Jiangsu (CN); Xifeng Zhu, Nanjing, Jiangsu (CN); Hang Ding, Nanjing, Jiangsu (CN)

(21) Appl. No.: 16/482,260

(22) PCT Filed: Sep. 4, 2018
(86) PCT No.: PCT/CN2018/104024

§ 371 Date: Jul. 31, 2019

(30) Foreign Application Priority Data
Dec. 14, 2017 (CN) 201711345964.X

(51) Int. Cl. G06F 17/27; G10L 15/22; G10L 15/26; H04L 29/08; G06F 3/16; G06K 9/00

(52) U.S. Cl. CPC G06F 17/2785; G10L 15/22; G06K 9/00483; H04L 67/10; G06F 3/167; G10L 15/26

(57) ABSTRACT

An intelligent visual inquiry method and system, the method comprising: a service provider preparing pre-set questions and recording answers in videos, uploading the pre-set questions and answer videos to a cloud server, and setting keywords for the pre-set questions; the inquiry device receiving an audio question of a user asking questions and uploading the audio question to an Internet cloud server; the cloud server carrying out voice recognition and semantic analysis on the audio question, and determining whether there is a matching question in a question library; if there is a question successfully matching same in the question library, sending the answer video to an inquiry device, and the inquiry device playing same; and if there is no question successfully matching same in the question library, storing the question in an unanswered area of the cloud server, and sending matching failure information to the inquiry device, and the inquiry device playing a pre-set video that cannot be understood.

### TECHNICAL FIELD

The invention relates to the technical field of Internet smart device, in particular to an intelligent visual inquiry method and system.

### BACKGROUND ART

In order to enhance user experience and better answer questions from users, most companies have their own customer service departments. However, the conventional customer services are mainly in the form of interaction between users and customer service personnel, on the one hand, the daily workload of the customer service personnel is large, daily repeated and cumbersome questions are answered, and the user's questions cannot be answered online 24 hours a day, on the other hand, the companies need to pay huge labor cost. Therefore, the traditional customer service in manual form can not meet the requirements of users and for cost control of enterprises.

With the continuous development of Internet technology, people began to turn their attention to the customer service form of intelligent human-machine interaction. However, the prior form of intelligent human-machine interaction is relatively simple, in general, the service providers pre-set the answers of problems users may encounter in the server in the form of text, and when the users input corresponding questions, the server sends the pre-set answers to users. The above-mentioned customer service form has low intelligence degree, and the text-based answering method thereof is not intuitive enough, it will be boring for a long time.

### SUMMARY OF THE INVENTION

In order to solve disadvantages of the prior art, the invention aims to provide an intelligent visual inquiry method and system, which can provide a user with intelligent video “virtual simulation” customer service, the invention can not only provide professional and accurate question and answer service for users, but also be more intuitive, understandable, humanistic, vivid and interesting than text reply.

In order to achieve the above objectives, the invention adopts the following technical scheme: an intelligent visual inquiry method and system:

step 1: a service provider preparing pre-set questions and corresponding answers, recording answers in videos,

step 2: the service provider uploading the pre-set questions and corresponding answer videos to question library in a cloud server, and setting keywords for each pre-set question; dividing keywords into several different levels, and setting parallel keywords with same or similar meanings and different pronunciations for the keywords in different levels;

step 3: inquiry device receiving an audio question of a user asking questions and uploading the audio question to an Internet cloud server;

step 4: the cloud server carrying out voice recognition on the audio question, and converting the audio question into text question;

step 5: the cloud server carrying out semantic analysis on the text question, and reversely matching the text question with corresponding keywords in different levels and parallel keywords of the pre-set questions in the question library; determining whether successfully matching with the keywords in different levels or the parallel keywords thereof, if yes, successfully matching with the pre-set questions in the question library and conducting step 6, if no, unsuccessfully matching with the pre-set questions in the question library and conducting step 7;

step 6: sending the corresponding answer video of the successfully matched pre-set question to an inquiry device, and the inquiry device playing same;

step 7: storing the unsuccessfully matched text question in an unanswered area of the cloud server, and sending matching failure information to the inquiry device, and the inquiry device playing a pre-set video that cannot be understood.

Further, in step 7, after storing the unsuccessfully matched text question in an unanswered area of the cloud server, the method also comprises following steps: the service provider acquiring the unsuccessfully matched text question from the unanswered area of the cloud server, adding corresponding answers, recording answers in videos, and repeating the step 2.

Further, in step 6, in the process of playing answer videos, users can interrupt playing and return to step 3.

Further, the answer videos are live-action videos.

Further, in the step 6, in the process of inquiry device playing answer videos, the inquiry device overlapping translucent visual window on video play surface, the visual window displays operation surface or information relative to the answer videos.

An intelligent visual inquiry system, comprising an inquiry device and a cloud server, the inquiry device and the cloud server transmit data over the Internet; the inquiry device is used for receiving asked questions of a user asking questions, uploading questions to the cloud server and receiving the answer videos returned by the cloud server, and playing answer videos; the cloud server is used for storing the pre-set questions and answer videos, receiving questions sent by the inquiry device, analyzing and matching the questions, and sending matching results to the inquiry device.

Further, the inquiry device comprises a processor, a recording unit, a touch control display unit and a communication unit, the processor is connected to the recording unit, the touch control display unit and the communication unit respectively; the recording unit is used for acquiring the audio question of a user asking questions; the touch control display unit is used for operation of a user asking questions and displaying videos; the communication unit is used for data transmitting with the cloud server.

Further, the cloud server comprises: a receive push module for receiving data uploaded by inquiry device and sending data to the inquiry device; an audio converting module, connecting to the receive push module and used for converting audio into text; a matching module for matching corresponding pre-set questions and answer videos from question library; a storing module for storing the pre-set questions, answer videos and keywords uploaded by the service provider, and storing matching failure information.

Further, the storing module is logically divided into a database and an unanswered area, the database is used for storing the pre-set questions, answer videos and keywords uploaded by the service provider, and the unanswered area is used for storing matching failure information.

The invention has the following advantageous effects:

In the invention, an intelligent visual inquiry method and system, a user asking questions can present in oral questions intended to be raised, after the inquiry device receiving questions, the questions are uploaded to cloud server and analyzed, according to the analysis result, the matched answer videos are selected from the question library and returned to the inquiry device, the inquiry device playing videos to the user to answer the questions, compared to traditional form of “virtual customer service” text questions and answers, the invention is more intuitive, understandable, novel, vivid and interesting. In addition, the system can run 24 hours a day, providing professional and accurate customer service in real time.

### BRIEF DESCRIPTION OF THE DRAWINGS

FIG. 1 schematically shows the flow chart of a visual inquiry method of the invention;

FIG. 2 schematically shows the connection of a visual inquiry system of the invention;

FIG. 3 schematically shows the appearance of a vertical inquiry device;

FIG. 4 schematically shows the appearance of a wall-mounted inquiry device.

### PREFERRED EMBODIMENTS OF THE INVENTION

The invention will be further described below in reference to accompanying drawings and specific embodiments.

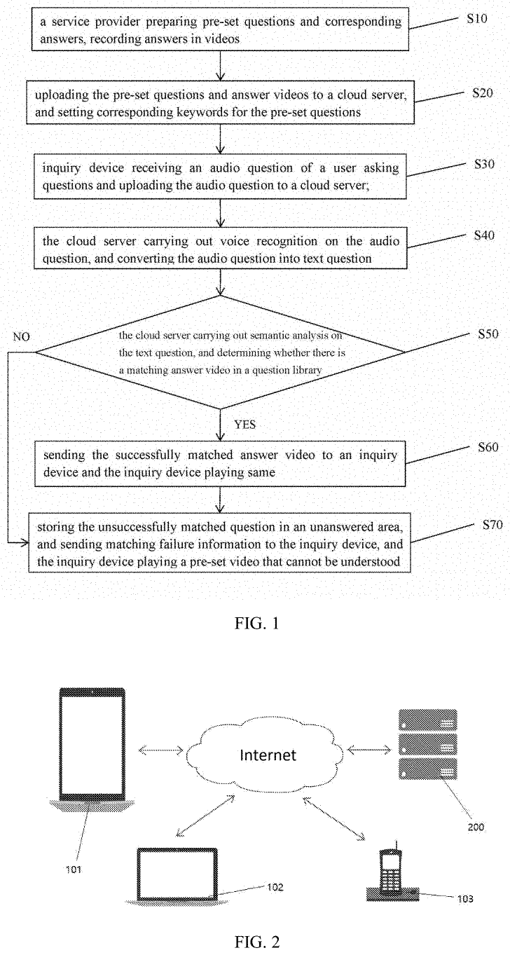

According to FIG. 1, an intelligent visual inquiry method of the invention, comprising following steps:

S10, a service provider preparing pre-set questions and corresponding answers, recording answers in answer videos. In order to save the storage space of the cloud server, reduce the network flow, and improve the playing efficiency of the inquiry device, the videos uploaded by the service provider can be compressed. The answer videos are live-action videos, the live person can be customer service personnel, official spokesmen or somebody the like of the service provider.

S20, the service provider uploading the pre-set questions and answer videos to question library in a cloud server, and setting keywords for each pre-set question, dividing the keywords into several different levels, such as, level one, level two, level three. Moreover, setting parallel keywords for the keywords, the parallel keywords are words with similar meaning to the keywords or words with the same meaning but different pronunciation to the keywords (for example, the common words formed due to incorrect pronunciation or dialect words).

S30, the inquiry device receiving an audio question of a user asking questions and uploading the audio question to an Internet cloud server. Wherein, the input device of the inquiry device is a recording unit, for example, microphone, the user asking questions merely need to simply ask the question directly, the recording unit of the inquiry device may acquire the audio data of the question user asked. The audio data of the question is uploaded to the cloud server of the Internet for further processing of the cloud server.

S40: the cloud server carrying out voice recognition on the received audio question, and converting the audio question into corresponding text question.

S50, the cloud server carrying out semantic analysis on the text question, and reversely matching the text question with corresponding keywords in different levels and parallel keywords of the pre-set questions in the question library. Wherein, the keywords with higher level are matched first (level one is the highest, followed by level two, level three, and so on), when the matching of keywords in higher level is unsuccessful, the matching of keywords in next level is performed, and so on, the matching is successful if there is one keyword is matched at all levels, and the answer video corresponding to the keyword is found. It should be noted that the parallel keywords are attached to the corresponding keywords, therefore the parallel keywords and the corresponding keywords are in the same level, and the matching of keyword in the same level has no priority. If successfully matching with the pre-set questions in the question library, conducting step S60, if unsuccessfully matching with the pre-set questions in the question library and conducting step S70.

S60: sending the corresponding answer video of the successfully matched pre-set question to an inquiry device, and the inquiry device playing same; wherein, in the process of the inquiry device playing videos, the user can interrupt the playing video and ask a new question if the user asking questions feels that the returned answer video is wrong or wants to ask a new question. In order to enable the user to continue to perform other operations during the video playing, a translucent visual window is overlapped on video play surface, operation surface is displayed in the visual window. In addition to displaying the user interface when video playing, the translucent visual window can also display some information mentioned in the answer video, for example, when the user inquiring some commodity, the information of the commodity like specific performance parameters and price may be displayed in the translucent window, thereby the user can have a comprehensive understanding of the commodity.

An unanswered area is divided in the storing area of the cloud server for storing unsuccessfully matched questions in the cloud server. The question is stored in the unanswered area when there is no question successfully matching. The unanswered questions stored in the unanswered area are sent to the service provider, and the service provider organizes to the corresponding answer videos, repeating the step S20, and adding the new questions and answer videos into the question library of the cloud server.

S70, if there is no question successfully matching same in the question library, sending matching failure information to the inquiry device, and the inquiry device playing a pre-set video that cannot be understood to indicate answer of the asked question can not be found. The video that cannot be understood can be characteristic videos recorded by the service provider, or some fixed video.

As shown in FIG. 2, the invention also comprises:

an intelligent visual inquiry system, comprising an inquiry device (101, 102, 103) and a cloud server 200, the inquiry device (101, 102, 103) and the cloud server 200 transmit data over the Internet. The inquiry device (101, 102, 103) is used for receiving asked questions of a user, uploading questions to the cloud server and receiving the answer videos returned by the cloud server, and playing answer videos. The inquiry device may be vertical 101, wall-mounted 102 or portable 103. The cloud server 200 is used for storing the pre-set questions and answer videos, receiving questions sent by the inquiry device (101, 102, 103), analyzing and matching the questions, and sending matching results to the inquiry device (101, 102, 103).

The inquiry device (101, 102, 103) comprises a processor, a recording unit, a touch control display unit and a communication unit, the processor is connected to the recording unit, the touch control display unit and the communication unit respectively; the recording unit is used for acquiring the audio question of a user asking questions; the touch control display unit is used for operation of a user asking questions and displaying videos; the communication unit is used for data transmitting with the cloud server.

The cloud server comprises: a receive push module for receiving data uploaded by inquiry device and sending data to the inquiry device; an audio converting module, connecting to the receive push module and used for converting audio into text; a matching module for matching corresponding pre-set questions and answer videos from question library; a storing module for storing the pre-set questions, answer videos and keywords uploaded by the service provider, and storing matching failure information. The storing module is logically divided into a database and an unanswered area, the database is used for storing the pre-set questions, answer videos and keywords uploaded by the service provider, and the unanswered area is used for storing matching failure information.

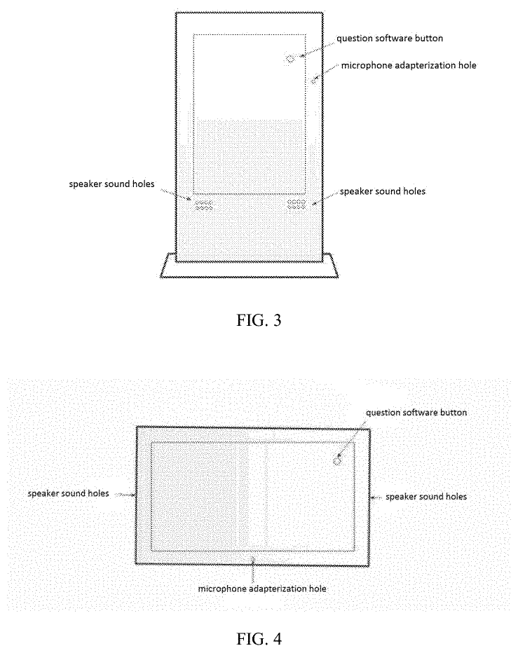

As shown in FIG. 3 and FIG. 4, the input devices of the inquiry device comprise a microphone and a touch screen, microphone adapterization hole is set at a height of about 1.5 meters from the ground on both sides of the touch screen, which is close to the height of the common human mouth, thereby the microphone adapterization is close to the shortest distance.

The inquiry device is provided with network port RJ45 and antenna, the network port RJ45 is used for connecting to the extranet of the Internet and the antenna is used for connecting to the extranet of the Internet through WIFI. In addition, 220V alternating current power supply is needed.

Operation system is provided inside the inquiry device, such as Android operating system, Windows operating system and the like, specific software is also provided, and the cloud server is provided with corresponding software, the information transmission between the inquiry device and the cloud server can be achieved by accessing the Internet through software, thereby the function of human-machine interaction can be achieved.

The basic principles, main features and advantages of the invention have been shown and described above. It should be understood by those skilled in the art that the above embodiments are not intended to limit the invention in any way, and the technical solutions obtained by means of equivalent substitution or equivalent transformation should be included within the scope of the invention.

1. An intelligent visual inquiry method, comprising following steps:
step 1: a service provider preparing pre-set questions and corresponding answers, recording answers in videos;
step 2: the service provider uploading the pre-set questions and answer videos to question library in a cloud server, and setting keywords for each pre-set question; dividing keywords into several different levels, and setting parallel keywords with same or similar meanings and different pronunciations for the keywords in different levels;
step 3: inquiry device receiving an audio question of a user asking questions and uploading the audio question to an Internet cloud server;
step 4: the cloud server carrying out voice recognition on the audio question, and converting the audio question into text question;
step 5: the cloud server carrying out semantic analysis on the text question, and reversely matching the text question with corresponding keywords in different levels and parallel keywords of the pre-set questions in the question library; determining whether successfully matching with the keywords in different levels or the parallel keywords thereof, if yes, successfully matching with the pre-set questions in the question library and conducting step 6, if no, unsuccessfully matching with the pre-set questions in the question library and conducting step 7;
step 6: sending the corresponding answer video of the successfully matched pre-set question to an inquiry device, and the inquiry device playing same;
step 7: storing the unsuccessfully matched text question in an unanswered area of the cloud server, and sending matching failure information to the inquiry device, and the inquiry device playing a pre-set video that cannot be understood.

2. The intelligent visual inquiry method of claim 1, wherein in step 7, after storing the unsuccessfully matched text question in an unanswered area of the cloud server, the method also comprises following steps: the service provider acquiring the text question unsuccessfully matched from the unanswered area of the cloud server, adding corresponding answers, recording answers in videos, and repeating the step 2.

3. The intelligent visual inquiry method of claim 1 or 2, wherein in step 6, in the process of playing answer videos, users can interrupt playing and return to step 3.

4. The intelligent visual inquiry method of claim 1 or 2, wherein the answer videos are live-action videos.

5. The intelligent visual inquiry method of claim 1 or 2, wherein in the step 6, in the process of inquiry device playing answer videos, the inquiry device overlapping translucent visual window on video play surface, the visual window displays operation surface or information relative to the answer videos.

6. An intelligent visual inquiry system, comprising an inquiry device and a cloud server, the inquiry device and the cloud server transmit data over the Internet; the inquiry device is used for receiving asked questions of a user asking questions, uploading questions to the cloud server and receiving the answer videos returned by the cloud server, and playing answer videos; the cloud server is used for storing the pre-set questions and answer videos, receiving questions sent by the inquiry device, analyzing and matching the questions, and sending matching results to the inquiry device.

7. The intelligent visual inquiry system of claim 6, wherein the inquiry device comprises a processor, a recording unit, a touch control display unit and a communication unit, the processor is connected to the recording unit, the touch control display unit and the communication unit respectively; the recording unit is used for acquiring the audio question of a user asking questions; the touch control display unit is used for operation of a user asking questions and displaying videos; the communication unit is used for data transmitting with the cloud server.

8. The intelligent visual inquiry system of claim 6 or 7, wherein the cloud server comprises: a receive push module for receiving data uploaded by inquiry device and sending data to the inquiry device; an audio converting module, connecting to the receive push module and used for converting audio into text; a matching module for matching corresponding pre-set questions and answer videos from question library; a storing module for storing the pre-set questions, answer videos and keywords uploaded by the service provider, and storing matching failure information.

9. The intelligent visual inquiry system of claim 8, wherein the storing module is logically divided into a database and an unanswered area, the database is used for storing the pre-set questions, answer videos and keywords uploaded by the service provider, and the unanswered area is used for storing matching failure information.
